(19) United States
(12) Patent Application Publication
(10) Pub. No.: US 2002/0075316 A1
(43) Pub. Date: Jun. 20, 2002

(54) System and method for a field type intelligent web portal

(75) Inventor: Glenn Dardick, Maidens, VA (US)

Correspondence Address: GREENBERG-TRAURIG, 1750 TYSONS BOULEVARD, 12TH FLOOR, MCLEAN, VA, 22102, US

(73) Assignee: Dardick Technologies, Richmond, VA (US)

(21) Appl. No.: 09/865,489

(22) Filed: May 29, 2001

Related U.S. Application Data
(60) Provisional application No. 60/207,145, filed on May 26, 2000.

(51) Int. Cl. G09G 5/00

(52) U.S. Cl. 345/808

(57) ABSTRACT

A system and method for an improved user interface compatible with both traditional computer pointing devices and touch-screen displays. Properties, methods, and hooks may be exposed by the present invention which allow programmers and web designers to create custom applications based on the present invention while customizing the behavior of the present invention to suit specific user-interface requirements.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

This application claims the benefit of U.S. Provisional Patent Application No. 60/207,145 filed on May 26, 2000, the entire disclosure of which is incorporated herein by reference.

This application is related to U.S. patent application Ser. No. 09/721,511 filed Nov. 22, 2000 and further related to U.S. patent application filed May 29, 2001 titled “System and Method For an On-Demand Script-Activated Virtual Keyboard” by inventor Glenn Dardick”; and U.S. patent application filed May 29, 2001 titled “System and Method For an On-Demand Script-Activated Selection Dialog Control” by inventor Glenn Dardick, the entire disclosures of which are incorporated herein by reference.

### FIELD OF THE INVENTION

The present invention relates to the field of computer interface design, and, in particular, the present invention provides a tool through which controls, such as those generated by an operating system in response to Hypertext Markup Language commands <INPUT> and <SELECT>, may be replaced by other controls, thereby improving a user interface.

### BACKGROUND OF THE INVENTION

Computers are becoming increasingly prolific. From handheld organizers to notebook computers to Automated Teller Machines (ATMs) to information kiosks, computers are all around us. However, as computers continue to permeate our society, one overriding problem remains: how to create more intuitive human/computer interfaces.

For many years, keyboards and pointing devices, such as joysticks and mice, have been preferred for allowing humans to interact with computers. However, such input mechanism require a significant learning curve, and are thus not well suited for devices such as kiosks and ATM machines which are used by the general public. The need for a more intuitive user-interface element has spurred the development of touch-sensitive display devices, such as that taught by U.S. Pat. No. 5,777,596 to Herbert.

As touch-sensitive displays have become increasingly popular, those designing handheld devices, kiosks, ATMs, and the like have created unique user-interfaces which structure interaction around visual elements on a touch-sensitive display. However, such user-interfaces have typically been custom-written, and those few which are not custom-written rely on low-resolution displays to facilitate user interaction. For example, touch-screen displays using standard, operating system provided dialog boxes, drop-down lists, text boxes, or other controls typically use displays at low resolutions. Low resolution displays are used because they allow visually or physically impaired individuals to easily interact with a kiosk or ATM.

### SUMMARY OF THE INVENTION

The present invention improves upon the prior art by enhancing the usability of existing technologies when applied to touch-screen displays. In particular, the present invention allows kiosk and ATM designers to create a single interface which may be used by both traditional computer users and those using touch-screen displays. The present invention may function as a user interface enhancement, intercepting and performing control-based functions in lieu of operating system created controls, or other, similar controls.

The present invention may allow software developers and web site designers to utilize existing software, such as web browsers, rather than requiring that new software be developed for each supported user interface method. The present invention may include software developed in a standardized programming language, such as, but not limited to JAVA or C++. Such software may intercept control-level commands and perform necessary functions. The present invention may further be structured to allow access and manipulation of the present invention by other software or hardware.

### BRIEF DESCRIPTION OF THE DRAWINGS

FIG. 1 is a screen capture illustrating a traditional kiosk touch-screen which includes a text box and two drop-down lists, each examples of controls supported by the present invention.

FIG. 2 is a screen capture illustrating a traditional kiosk touch-screen after the activation of a drop-down box.

FIG. 3 is a screen capture illustrating a traditional kiosk touch-screen after the activation of a text box control.

### DETAILED DESCRIPTION OF THE PREFERRED EMBODIMENT

The present invention allows software developers or web site designers to create a single user interface which may be used by persons interacting with either a home computer and pointing device or a touch-screen display. The present invention thus frees software developers and web site designers from the low-resolution user interfaces commonly seen in kiosks, ATM's, and the like, allowing them to create more visually pleasing user interfaces while preserving the ease of use which users expect from a touch-screen based system.

By way of example, without intending to limit the present invention, a 1024 pixel by 768 pixel (“1024×768”) display has over 2.5 times the display area of a 640 pixel by 480 pixel (“640×480”) display. However, most kiosk and ATM designers limit their designs to 640×480 displays because operating system generated dialog boxes are 2.5 times smaller on a 1024×768 display, and are therefore more difficult for visually or physically impaired individuals to properly interact. The present invention allows a software developer or web site designer to utilize a 1024×768 (or higher resolution) display, while still presenting users with controls and other user interface elements which can be easily read and with which a user may easily interact.

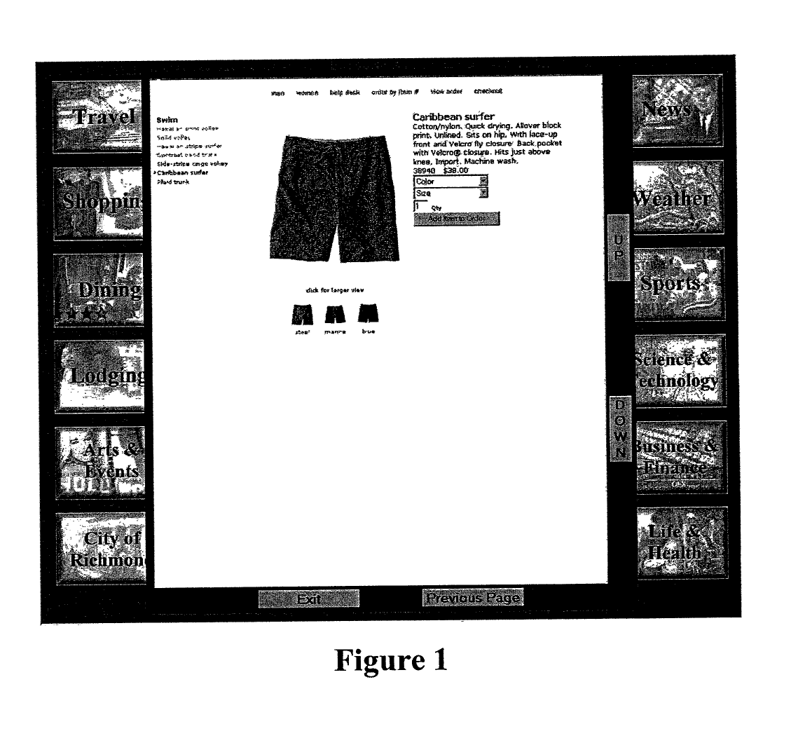

FIG. 1 is a screen capture illustrating a traditional kiosk touch-screen which includes a text box and two drop-down lists, each examples of controls supported by the present invention. A user may utilize such a screen to order clothing or other items, and a user placing such an order may first be required to select from a list of available options. Selection of such options may begin with a user touching a screen in the area of a drop-down list or other control containing a list of available options. Such controls may be created using calls to an operating system, or to an operating system component, such as a dynamic link library.

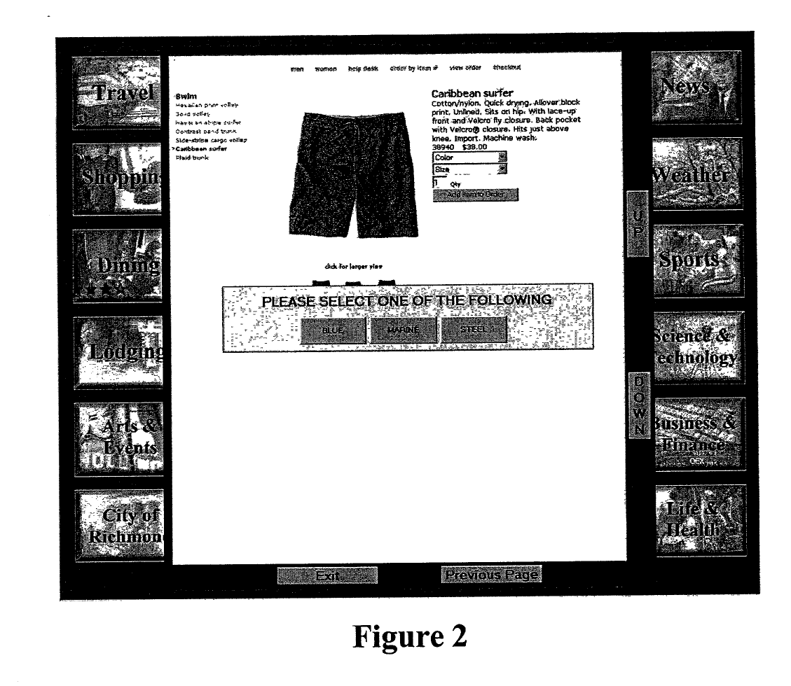

Typically, a web browser or other software passes user input processing responsibilities to a selected control and sit idle while such interaction is allowed to occur. The present invention may intercept such processing changes, display controls associated with the present invention, and pass user input back to a web browser or other software. For example, a dialog box or other user interface element, such as that illustrated in FIG. 2, may be displayed if a user selects a drop-down list.

FIG. 2 is a screen capture illustrating a traditional kiosk touch-screen after the activation of a drop-down box. The dialog box illustrated in FIG. 2 is similar to that described in U.S. Provisional Patent Application filed May 26, 2000, entitled “System and Method for an On-Demand Script-Activated Selection Dialog Control,” by inventor Glenn Dardick, the entire disclosure of which is incorporated herein by reference.

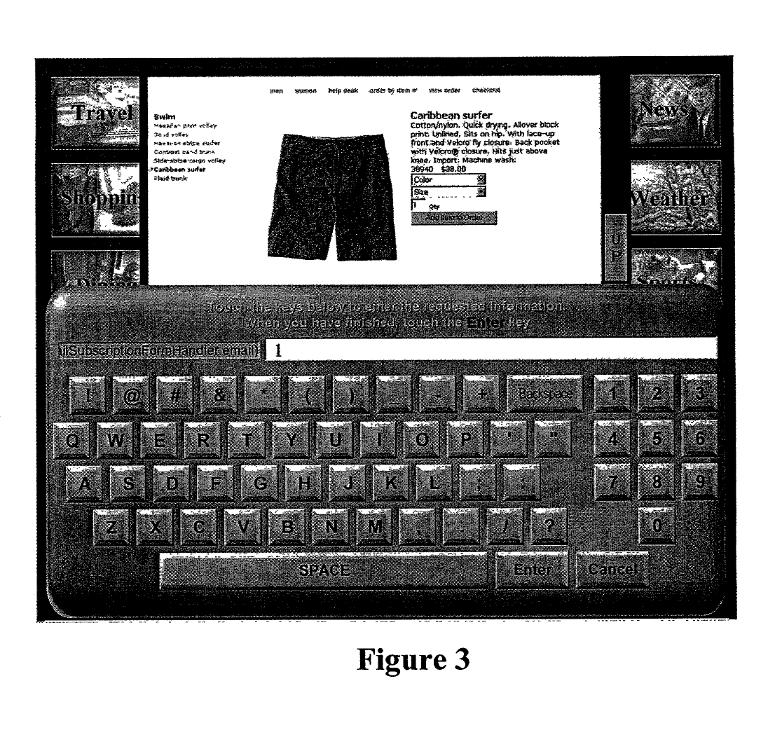

If a control requires alphanumeric input, activation of such a control may cause an alternative screen, similar to that illustrated in FIG. 3, to be displayed. Examples of such controls include text boxes, such as those displayed by a web browser when an Hypertext Markup Language (HTML) <INPUT> tag is encountered. FIG. 3 is a screen capture illustrating a traditional kiosk touch-screen after the activation of a text box control. The software keyboard illustrated in FIG. 3 is similar to that described in U.S. Provisional Patent Application filed May 26, 2000, entitled “System and Method for an On-Demand Script-Activated Virtual Keyboard” by inventor Glenn Dardick, the entire disclosure of which is incorporated herein by reference.

In addition to the controls illustrated in FIGS. 2 and 3, the present invention may further allow software developers to substitute custom controls for controls supplied by an operating system. Methods and properties of the present invention may also be exposed, allowing software developers to create custom applications utilizing the architecture provided by the present invention.

Appendix A shows source code useful for practicing the invention. The present invention is particularly useful in combination with publicly accessible kiosks such as that taught in U.S. Provisional Patent Application No. 60/167,232 filed Nov. 24, 1999, the entire disclosure of which is incorporated herein by reference.

While the preferred embodiment and various alternative embodiments of the invention have been disclosed and described in detail herein, it will be apparent to those skilled in the art that various changes in form and detail may be made therein without departing from the spirit and scope thereof.

[image]

[image]

[image]

[image]

[image]

[image]

[image]

[image]

[image]

[image]

[image]

[image]

[image]

[image]

[image]

[image]

[image]

[image]

[image]

I claim:

1) In a computer system operable with selection controls, a system for a field type intelligent web portal comprising:
a software or hardware control;
means for intercepting processing changes from a hardware or software control;
means for displaying controls;
means for passing user input to an underlying application.

2) The computer system of claim 1, wherein the controls displayed are alternative to the software or hardware control.

3) The computer system of claim 1, wherein the means allow for the substitution of controls provided by the operating system.

4) The computer system of claim 1, wherein the means allow for customization for the display of the alternative control.

5) In a computer system operable with selection controls a method for providing a field type intelligent web portal comprising:
intercepting processing changes from a hardware or software control;
displaying controls alternative the hardware or control having its processing changes intercepted; and
passing user input back to an underlying application.

6) A method according to claim 5, wherein displaying includes displaying controls that are configurable by a user.

7) A method according to claim 5, wherein displaying includes displaying controls that substitute for the controls of the operating system.
